(19) United States
(12) Patent Application Publication
(10) Pub. No.: US 2013/0327220 A1
(43) Pub. Date: Dec. 12, 2013

(54) Multilayer Complex And Use Thereof For Manufacturing Parts Made Of A Composite Material, And Method For Manufacturing Such A Part

(71) Applicant: Bernard De Mulatier, LYON (FR)

(72) Inventor: Bernard De Mulatier, LYON (FR)

(21) Appl. No.: 13/964,800

(22) Filed: Aug. 12, 2013

Related U.S. Application Data
(63) Continuation of application No. PCT/FR2012/050247, filed on Feb. 6, 2012.

(30) Foreign Application Priority Data
Feb. 14, 2011 (FR) 1151200

(51) Int. Cl. F03D 1/06

(52) U.S. Cl. CPC F03D 1/0675
USPC 96/12; 96/11; 264/571

(57) ABSTRACT

A multilayer complex for the vacuum molding of a composite part containing a fibrous reinforcement and a polymer resin, including a peel-ply fabric combined with a microporous membrane which is at least pervious to gases.

### FIELD OF THE INVENTION

The invention relates to a multilayer complex comprising a peel-ply fabric and a microporous membrane, for the vacuum molding of parts made of a composite material.

The fields of application of the present invention especially include aeronautics, the manufacturing of wind turbine blades, of boats hulls, or of automobile parts.

### BACKGROUND OF THE INVENTION

A composite material comprises at least one fibrous material and one liquid material which, when combined, provide a complex having properties surpassing those of the initial materials. Thus, parts made of a composite material have many advantages, especially due to their resistance, lightness and easy shaping properties. Such parts may be formed by vacuum molding or by vacuum infusion.

Generally, such techniques essentially comprise uniformly diffusing resin inside of a fibrous reinforcement having the shape of the part to be manufactured. After discharge of the gases and spreading of the resin, the latter is reticulated to provide a part made of composite material.

Document FR 2 868 008 A1 of the Applicant describes the manufacturing by vacuum molding of a part made of composite material impregnated with a polymer resin. The molding is eased by the use of a multilayer complex, especially during the placing under vacuum of the fibrous reinforcement and the uniform distribution of the resin.

The multilayer complex described in FR 2 868 008 A1 successively comprises a peel-ply fabric, a film pervious to gases, and a bleeder felt. The peel-ply fabric enables to structure the surface of the composite material part while the bleeder and the film pervious to gases enable to homogenize the gas discharge. The film pervious to gases is a perforated three-layer film having an upper layer coming into contact with the textile playing the role of bleeder, a central layer, and a lower layer coming into contact with the peel-ply fabric. It should be noted that the peel-ply fabric and the resin are chemically incompatible and that the peel-ply fabric is not totally impervious to resin. Indeed, this film is mechanical perforated and thus has holes of dimensions which do not enable to integrally retain the resin.

Such a complex however has the advantage of being removable by delamination, by successively removing the felt with the film, and the peel-ply fabric.

Satisfactory though it may be, the use of such a multilayer complex may result consuming too much resin with the new generations of impregnated fibers, due to its perforated membrane, which may affect the mechanical performance of the composite material. It further implies an additional cost since it uses an amount of resin greater than the needed quantity, since the perforated three-layer film can easily let resin through it.

### SUMMARY OF THE INVENTION

The Applicant has developed a multilayer complex for the vacuum molding of parts made of composite material, which is very easy to use and enables to decrease the amount of resin used.

More specifically, the present invention relates to a multilayer complex for the vacuum molding of a composite part containing a fibrous reinforcement and a polymer resin, comprising a peel-ply fabric combined with a microporous membrane which is at least pervious to gases.

For more clarity, gas here means any gas, be it heavy or light, and also any compound in gaseous form.

Advantageously, the multilayer complex according to the present invention has a thickness ranging between 130 and 270 μm, and more advantageously between 180 and 210 μm.

Generally, a composite part is prepared by means of a fibrous reinforcement and a resin. The reinforcement is advantageously made of carbon or of glass fibers. It may especially be a reinforcement pre-impregnated with resin.

Prepregs capable of being used in the context of the invention generally have a fiber-to-resin ratio (by weight) ranging between 50/50 and 90/10. Such a ratio more generally is on the order of 70/30.

The resin advantageously is a thermosetting polymer resin which reticulates at ambient temperature or at high temperature. In the case of prepregs, the reticulation is generally obtained between 150 and 200° C.

To better understand the scope of the invention and the function of the multilayer complex and of its components in the vacuum molding of a part made of composite material, it is necessary to briefly define the steps of the vacuum molding:
forming in a mold the draft of the part made of composite material; the draft comprising a fibrous reinforcement and resin;
covering the fibrous reinforcement with a multilayer complex;
possibly, in the absence thereof, installing a bleeder felt on the multilayer complex;
installing a bagging film above the multilayer complex or, possibly, on the bleeder;
installing a sealant between the mold and the bagging film;
discharging gases;
reticulating the resin;
peeling off the bagging film and, if present, the bleeder
peeling off the multilayer complex.

Conversely to perforated films of prior art, the microporosity of the membrane of the multilayer complex according to the present invention results from its manufacturing and not from a subsequent transformation by mechanical perforation. The pores of the microporous membrane of the invention have a much smaller diameter than the pores obtained by perforation of prior art membranes. Further, these pores are not necessary through pores, thus making the resin quasi-impervious, though however remaining pervious to gases.

In the context of the invention, the microporous membrane at least pervious to gases may advantageously contain a polymer selected from the group comprising polyolefins, polyurethanes (PU), and fluoropolymers. In a preferred embodiment, the membrane is made of polyethylene or of polytetrafluoroethylene (PTFE). It is more advantageously still made of polyethylene.

Expression “at least pervious to gases” means that the microporous membrane is pervious to gases, but that it is not necessarily pervious to resin. Advantageously, when the microporous membrane is placed under vacuum, its microporosity enables to discharge gases, as well as, especially, to evaporate residual solvents. The resin is almost totally retained by the microporous membrane. It is however possible for a minute fraction of the resin to pass through the microporous membrane. However, in an advantageous embodiment, the microporous membrane remains impervious to resin.

The membrane has an average permeability to gases greater than 1 liter/m²/s under 2,000 Pa. It is advantageously greater than 2.8 L/m²/s under 2,000 Pa.

Advantageously, the microporous membrane has a pore density ranging between 2 billion and 8 billion pores/cm³, and the pores of the microporous membrane have an average diameter smaller than 20 μm, and more advantageously still smaller than 6 μm. The membrane generally comprises pores having diameters ranging between 1 and 20 μm. In a specific embodiment, the pores of the microporous membrane have an average diameter ranging between 1 and 5 μm. Thus, the pore density is such that the volume of the microporous membrane comprises from 30 to 80% of vacuum.

Further, the microporous membrane has a thickness preferably ranging between 20 and 100 μm, and more preferably still between 30 and 50 μm.

When vacuum is created, the resin is homogenously distributed and impregnates the peel-ply fabric. It is almost integrally retained by the microporous membrane. In other words, the resin is blocked inside of the peel-ply fabric, even if traces of resin may pass through the microporous membrane.

The microporous membrane is pervious to gases and quasi impervious to resin, it is thus quasi semi-pervious. Its properties depend on its manufacturing conditions. Indeed, the pores of the membrane are not necessarily through pores. The permeability to gases is especially obtained due to the interstices formed between pores on manufacturing of the membrane.

The multilayer complex according to the present invention thus enables to retain most of the resin during the molding. This thus enables to limit resin losses and thus to use smaller quantities than prior art techniques or complexes.

As already mentioned, the multilayer complex of the invention comprises a microporous membrane associated with a peel-ply fabric. Different association means may be envisaged, provided for the general permeability of the membrane not to be substantially modified. Thus, the microporous membrane and the peel-ply fabric may advantageously be associated by gluing with glue dots. The glue dot density is such that the glue dots are positioned so that their centers are spaced apart by from 1 to 5 mm, and that the surface area taken up by said glue dots amounts to from 10 to 50% and more advantageously from 10 to 30% of the surface of the microporous membrane. The glue dot density generally ranges between 30 and 180 glue dots per cm² of the surface area of the microporous membrane. Further, the quantity of glue advantageously is between 5 and 20 g on a fabric between 80 and 85 g.

The glue is advantageously selected from the group especially comprising hot-melt, polyurethane, and acrylic glues.

The peel-ply fabric of the multilayer complex according to the present invention especially enables to structure the surface of the composite part after peeling off, especially to ease the bonding of subsequently-deposited layers such as glue, paint . . . . It also enables to peel off the membrane associated therewith by glue dots.

To avoid any compatibility with resin, the peel-ply fabric is advantageously based on polyester fibers, or on polyamide fibers. Indeed, on peeling off of the peel-ply fabric, the part made of composite material will be deteriorated if the peel-ply fabric and the resin are compatible.

The peeling off of the multilayer complex according to the present invention creates a structure on the composite part which thus has improved bonding properties.

Further, in a specific embodiment, the multilayer complex according to the present invention comprises a bleeder felt coming into contact with the membrane and associated with the membrane by gluing. The bleeder felt is preferably made of nonwoven polyester or polyamide. The basic weight of the bleeder felt may range between 20 and 400 g/m², and advantageously is on the order of 150 g/m².

The bleeder felt is advantageously associated with the microporous membrane as described previously for the association between the microporous membrane and the peel-ply fabric.

In this specific case, the multilayer complex comprises a peel-ply fabric, a microporous membrane, and a bleeder felt. It thus has a thickness greater than that previously indicated.

The present invention also relates to a method for manufacturing by vacuum molding a part made of composite material impregnated with a polymer resin, comprising the steps of:
forming in a mold the draft of the part made of composite material impregnated with the polymer resin, said draft comprising a fibrous reinforcement and the resin;
installing a multilayer complex comprising a peel-ply fabric associated with a microporous membrane at least pervious to gases, to totally cover said draft;
possibly arranging a bleeder felt on the multilayer complex when the multilayer complex comprises none;
installing a bagging film, to cover the multilayer complex and, possibly, the bleeder felt;
installing a sealant between the mold and the bagging film;
placing under vacuum and discharging the gases present between the bagging film and the mold;
reticulating the polymer resin;
removing the bagging film and, if present, the bleeder felt;
peeling off the multilayer complex.

It should be noted that the sealant may also be installed before the bagging film.

This method may thus comprise the steps of installing and removing a bleeder felt on and from the multilayer complex, when the latter comprises none.

Of course, the multilayer complex is positioned so that the peel-ply fabric faces the draft of the part made of composite material.

According to a specific embodiment, the multilayer complex comprises a bleeder felt associated with the microporous membrane by gluing with glue dots. The multilayer complex successively comprises a peel-ply fabric, the microporous membrane, and the bleeder felt.

In this method, the steps of gas discharge and of resin reticulation may be simultaneous. Indeed, the resin may start reticulating before or during the gas discharge. It is advantageously reticulated after discharge of the gases.

Such a method especially comprises a step of removing the peel-ply fabric to obtain the part made of composite material. Such a composite material part thus has a structured surface, the peel-ply fabric leaving its mark.

The invention and the resulting advantages will better appear from the following non-limiting drawings and examples, provided as an illustration of the invention.

### BRIEF DESCRIPTION OF THE DRAWINGS

FIG. 1 is a cross-section view of multilayer complex according to the present invention comprising a microporous membrane associated with a peel-ply fabric and possibly with a bleeder felt. The multilayer complex is arranged on a draft of a part made of composite material impregnated with the polymer resin located in a mold.

### DETAILED DESCRIPTION OF THE INVENTION

The method for manufacturing a part made of composite material impregnated with a polymer resin comprises several steps.

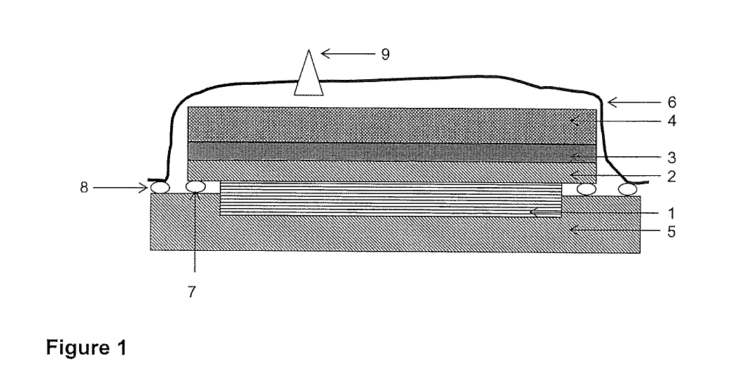

In FIG. 1, the fibrous reinforcement is a glass fiber fabric pre-impregnated with a resin (ratio 70/30, for example). It is placed in a mold (5) to form a draft (1) of the part made of composite material impregnated with the polymer resin.

A sealing joint gasket or sealant (7) may be placed around the draft, to isolate the mold area containing the fibrous reinforcement. It should be noted that the sealant (7) is optional in the case where the multilayer complex comprises a peel-ply fabric (2) associated with a microporous membrane (3) at least pervious to gases, arranged to totally cover the draft.

When it is not previously associated with the membrane (3), a bleeder felt (4) may advantageously be placed on the multilayer complex.

A bagging film (6) is then placed on a sealant (8), to cover the bleeder felt (4). Gases will be discharged by placing under vacuum (9). The gas discharge is thus performed through the microporous membrane of the multilayer complex. The gases are drained off by the bleeder felt (4). Further, the placing under vacuum enables to uniformly distribute the resin within the fibrous reinforcement. It also penetrates the peel-ply fabric (2).

The resin is then reticulated at ambient temperature or at high temperature in the case of prepregs.

After reticulation, the bagging film and the bleeder felt are peeled off. In the specific case where the multilayer complex comprises a bleeder felt associated with the membrane, the bleeder felt is peeled off by delamination. The membrane and the peel-ply fabric may be maintained in the composite material part as a protective film, and then removed later on for secondary operations.

### EXAMPLES OF EMBODIMENT

A composite material part is formed from a fibrous reinforcement and a polymer resin (ratio 70/30).

The fibrous reinforcement is a glass fiber fabric pre-impregnated with epoxy resin.

The multilayer complex comprises a microporous membrane made of PU as well as a polyamide peel-ply fabric (sold by DIATEX under reference PA85) and has a 160-μm thickness.

A microporous membrane such as sold by PROLINE, containing PU, which has a 55-μm thickness and a pore density equal to 8,000,000,000 pores/cm³, may be used. The membrane has pores with a diameter ranging between 1 and 5 μm. It is further associated with the peel-ply fabric by dots of PU glue. The glue dots have an average 0.6-mm diameter, and cover 25% of the membrane surface area. The membrane thus has approximately 90 glue dots per cm².

The multilayer complex is covered with a polyester bleeder felt having a 3-mm thickness. After installation of the polyamide bagging film, the draft is placed under vacuum, at 1 mbar abs for 120 minutes. The resin is then reticulated at 120° C. for 30 minutes.

1. A multilayer complex for the vacuum molding of a composite part containing a fibrous reinforcement and a polymer resin, comprising a peel-ply fabric combined with a microporous membrane which is at least pervious to gases.

2. The multilayer complex of claim 1, characterized in that the microporous membrane contains a polymer selected from the group consisting of polyolefins, polyurethanes, and fluoropolymers.

3. The multilayer complex of claim 1, characterized in that the microporous membrane has a pore density ranging between 2 billion and 8 billion pores/cm³, an average pore diameter being smaller than 20 μm.

4. The multilayer complex of claim 1, characterized in that the microporous membrane has a thickness ranging between 20 and 100 μm.

5. The multilayer complex of claim 1, characterized in that the microporous membrane has an average permeability of gases greater than 1 L/m²/s under 2,000 Pa.

6. The multilayer complex of claim 1, characterized in that the microporous membrane is associated with the peel-ply fabric by gluing with glue dots.

7. The multilayer complex of claim 6, characterized in that the glue dots are positioned so that their density is from 30 to 180 glue dots per cm² of a surface area of the microporous membrane and in that a surface area occupied by said glue dots amounts to from 10 to 50% of the surface area of the microporous membrane.

8. The multilayer complex of claim 1, characterized in that the peel-ply fabric is based on polyester or polyamide fibers.

9. The multilayer complex of claim 1, characterized in that the multilayer complex has a thickness ranging between 130 and 270 μm.

10. The multilayer complex of claim 1, characterized in that the multilayer complex comprises a bleeder felt coming into contact with the membrane, and associated with the membrane by gluing.

11. A method for manufacturing by vacuum molding a part made of a composite material impregnated with a polymer resin, comprising the steps of:
forming in a mold a draft of the part made of composite material impregnated with the polymer resin, said draft comprising a fibrous reinforcement and the resin;
installing a multilayer complex comprising a peel-ply fabric associated with a microporous membrane at least pervious to gases, to totally cover said draft;
installing a bagging film to cover the multilayer complex;
installing a sealant between the mold and the bagging film;
placing under vacuum and discharging gases present between the bagging film and the mold;
reticulating the polymer resin;
removing the bagging film;
peeling off the multilayer complex.

12. The method of claim 11, characterized in that said method further comprises a step of installing a bleeder felt on the multilayer complex and a step of removing the bleeder felt.

13. The method of claim 11, characterized in that the multilayer complex comprises a bleeder felt associated with the microporous membrane by gluing with glue dots.
